(19) United States
(12) Patent Application Publication
(10) Pub. No.: US 2013/0151484 A1
(43) Pub. Date: Jun. 13, 2013

(54) STORAGE DISCOUNTS FOR ALLOWING CROSS-USER DEDUPLICATION

(71) Applicant: Ezekiel Kruglick, Poway, CA (US)

(72) Inventor: Ezekiel Kruglick, Poway, CA (US)

(73) Assignee: Empire Technology Development, LLC., wilmington, DE (US)

(21) Appl. No.: 13/521,442

(22) PCT Filed: Dec. 8, 2011
(86) PCT No.: PCT/US11/63892

§ 371 Date: Jul. 10, 2012

(51) Int. Cl. G06F 17/30

(52) U.S. Cl. CPC G06F 17/30002
USPC 707/692

(57) ABSTRACT

Technologies are presented for deduplicating data storage across multiple separate users in a datacenter environment. In some examples, the deduplication may take into consideration separate encryption and packaging of various inactive data modules and machine instances, and may be performed based on customer proactive flagging of data as available for deduplication. Billing system records may be employed to track saved space for incentivizing users through discounts and as a garbage collection master reference for tracking usage of deduplication packages, which may otherwise be difficult in the multi-package environment.

### BACKGROUND

Unless otherwise indicated herein, the materials described in this section are not prior art to the claims in this application and are not admitted to be prior art by inclusion in this section.

With the advance of networking and data storage technologies, an increasing number of computing services are being provided to users or customers by cloud based datacenters that can enable leased access to computing resources at various levels. Datacenters can provide individuals and organization with a range of solutions for systems deployment and operation. While datacenters are equipped to deal with very large scales of data storage and processing, data storage still costs in terms of resources, bandwidth, speed, and fiscal cost of equipment. Another aspect of datacenter operations is duplication of data (e.g., applications, configuration data, and consumable data) among users. To ensure security, many datacenters provide encryption or similar mechanisms preventing unauthorized access to user data.

Data deduplication is the technology of using hashes or other semi-unique identifiers to identify stretches of identical data and replacing it with a single (or a few redundant) stored copy and pointers from each place the data is used to that master copy. Within a VDI (Virtual Desktop Infrastructure) in a private cloud, for example, deduplication may yield substantial impact because user operating systems are typically updated at the same time and essentially a single copy of the operating system and a majority of applications can be used to serve most users.

### SUMMARY

The present disclosure generally describes technologies for providing storage discounts for allowing cross-user deduplication.

According to some examples, a method for data storage deduplication across multiple users in a datacenter environment may include determining data storage flagged as available for deduplication, generating deduplication signatures from the flagged data storage, removing sections of the flagged data storage, replacing the removed sections with deduplication pointers, and updating a potential deduplication list with new deduplication signatures generated from the flagged data storage.

According to other examples, a server adapted to perform data storage deduplication across multiple users in a datacenter environment may include a memory adapted to store instructions and a processor configured to execute a data management application in conjunction with the stored instructions. The processor may determine data storage flagged as available for deduplication, generate deduplication signatures from the flagged data storage, remove sections of the flagged data storage, replace the removed sections with deduplication pointers, and update a potential deduplication list with new deduplication signatures generated from the flagged data storage.

According to further examples, a datacenter performing data storage deduplication across multiple users may include a plurality of data stores and at least one server for data management. The server may determine data storage flagged as available for deduplication, generate deduplication signatures from the flagged data storage, remove sections of the flagged data storage, replace the removed sections with deduplication pointers, and update a potential deduplication list with new deduplication signatures generated from the flagged data storage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example datacenter, where storage discounts for allowing cross-user deduplication may be provided;

FIG. 2 illustrates conceptually an example data deduplication in a simplified private cloud-based system scenario;

FIG. 3 illustrates an overview of deduplication realization;

FIG. 4 illustrates an example action flow and components in iteratively deduplicating and billing credits;

FIG. 5 a general purpose computing device, which may be used to implement a system for providing storage discounts for allowing cross-user deduplication;

FIG. 6 is a flow diagram illustrating an example method for providing storage discounts for allowing cross-user deduplication; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to providing storage discounts for allowing cross-user deduplication.

Briefly stated, technologies are presented for deduplicating data storage across multiple separate users in a datacenter environment. The deduplication may take into consideration separate encryption and packaging of various inactive data modules and machine instances, and may be performed based on customer proactive flagging of data as available for deduplication. Billing system records may be employed to track saved space for incentivizing users through discounts. The records may also be used as a garbage collection master reference for tracking usage of deduplication packages, which may otherwise be difficult in the multi-package environment.

As used herein, the term “storage discounts” refers to financial or comparable compensation that may be provided to a user of a data center for reduced data storage size based on deduplication of data (single user or cross-user). Such compensation may be in form of actual payments, reduction in datacenter fees, credits, or similar methods.

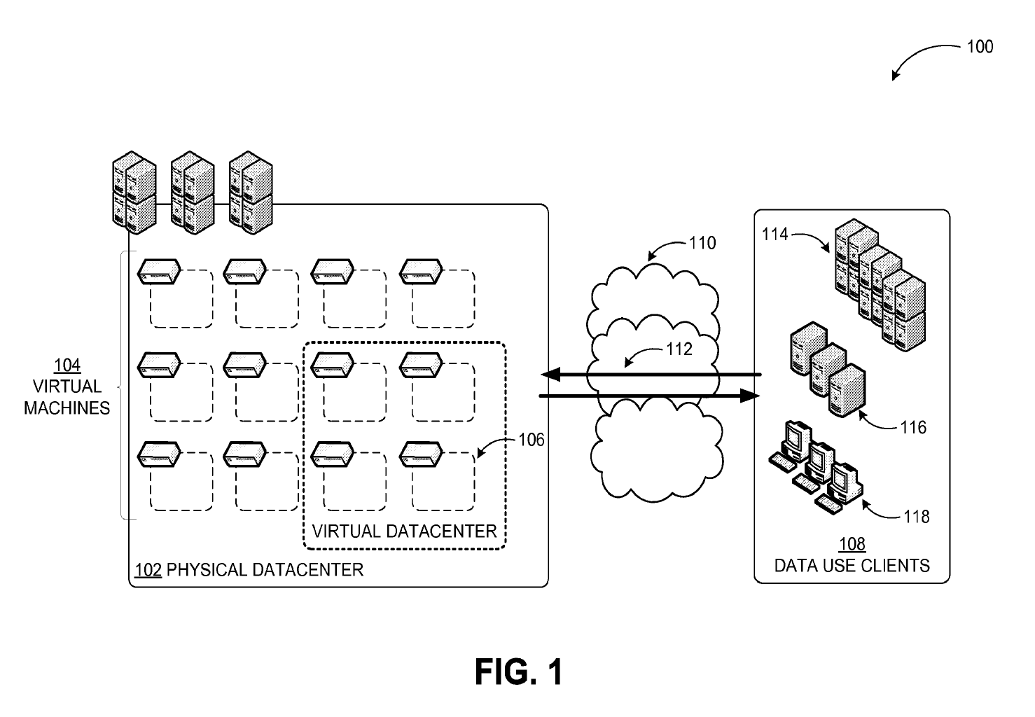

FIG. 1 illustrates an example datacenter, where storage discounts for allowing cross-user deduplication may be provided arranged in accordance with at least some embodiments described herein.

As shown in a diagram 100, a physical datacenter 102 may include a multitude of servers and specialized devices such as firewalls, routers, and comparable ones. A number of virtual servers or virtual machines 104 may be established on each server or across multiple servers for providing services to data use clients 108. In some implementations, one or more virtual machines may be grouped as a virtual datacenter 106. Data use clients 108 may include individual users interacting (112) with the datacenter 102 over one or more networks 110 via personal computing devices 118, enterprise clients interacting with the datacenter 102 via servers 116, or other datacenters interacting with the datacenter 102 via server groups 114.

Modern datacenters are increasingly cloud based entities. Services provided by datacenters include, but are not limited to, data storage, data processing, hosted applications, or even virtual desktops. In many scenarios, a substantial amount of data may be common across multiple users. For example, in a hosted application scenario, users may create copies of the same application with minimal customization. Thus, a majority of the application data, as well as some of the consumed data may be duplicated for a large number of users—with the customization data and some of the consumed data being unique. By deduplicating the common data portions, large amounts of storage space may be saved. Additional resources such as bandwidth and processing capacity may also be saved since that large amount of data does not have to be maintained, copied, and otherwise processed by the datacenter.

One roadblock in deduplicating data in a datacenter environment is security and privacy protection mechanisms provided to clients of the datacenter. For security and privacy purposes some or all of the data associated with individual clients may be encrypted or otherwise protected. Thus, even determining the portions of data that can be deduplicated can be a challenge. A system according to some embodiments enables cross-user deduplication of data by enabling users to proactively flag data portions as deduplicable.

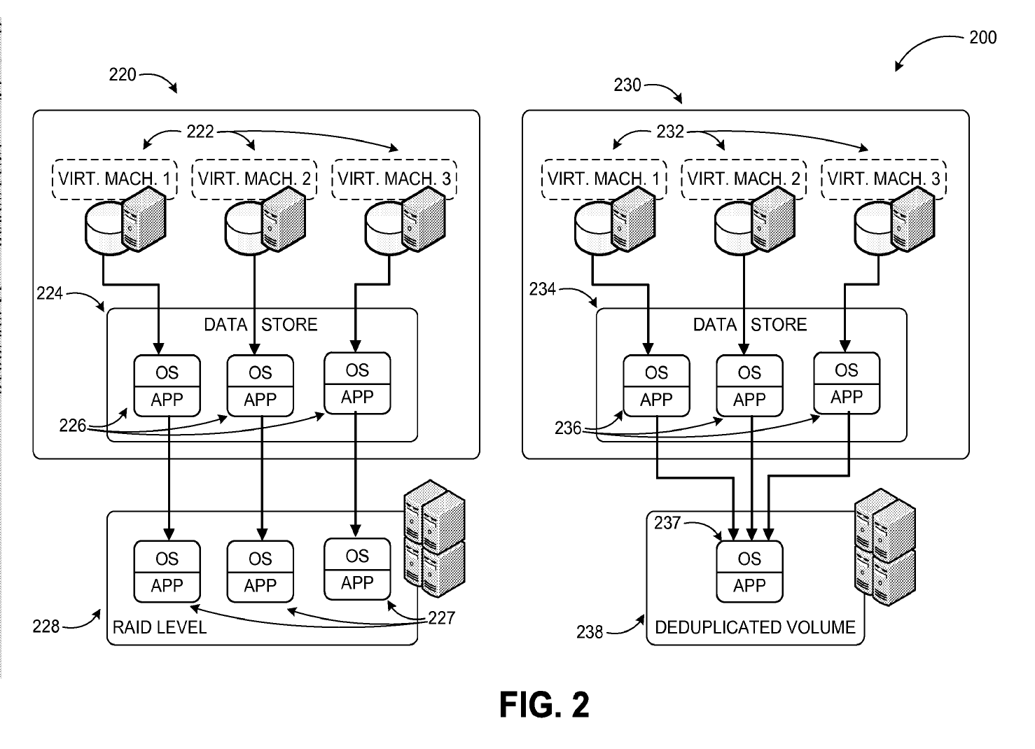

FIG. 2 illustrates conceptually an example data deduplication in a simplified private cloud-based system scenario arranged in accordance with at least some embodiments described herein.

A simple, example data deduplication scenario is illustrated in a diagram 200 of FIG. 2, where a single operating system and an application family are served to the users. In this scenario, one copy of the operating system and applications is sufficient for storage, although a few redundant copies may be stored for safety and performance In a conventional system 220 without deduplication, multiple virtual machines 222 may store individual copies of the operating system and applications 226 in a data store 224 and provide them to users. The copies of the operating systems and applications may also be stored at a RAID (Redundant Array of Independent Disks) level 228 as indicated by reference numeral 227.

When deduplication is applied to the same scenario, virtual machines 232 of a system 230 may again provide operating systems and applications 236 to a data store 234. Differently from the system 220, a single copy of the operating system and applications 237 may be stored in a deduplicated volume 238 and provided to users employing pointers to the actual storage location.

The above described scenario may not apply to datacenters with multiple tenants. While some service providers, for example, try to make it possible to a certain degree by allowing users to run library machine images for which no or reduced fee is charged for storage, achieving stability or almost any customization may require modifying the machine image. Thus, one option is to start with a library machine image, modify it by adding software packages or other changes, and then store it as a unique user image with associated storage space. The storage contained in the modified machine image may have a large number of blocks, files, or file segments that are completely identical to the library machine image. Unfortunately, once a machine image is customized or applications are added, it becomes user data and user storage may be specifically isolated in existing datacenters, often including separate encryption (managed by the datacenter) for each user.

If a user is enabled to designate certain block storage as “deduplication allowed” and the datacenter is enabled to perform cross-user (or even within-user) deduplication, a cost of replicating the data across datacenters, backing up the data, migrating machines that use the data, and so on may be substantially reduced. Users may be motivated to identify and indicate which data segments can be deduplicated if they realize some of this cost savings. In case of multiple machine images, the storage savings may amount to a majority of the actual storage volume.

A deduplication system according to some embodiments can work into multiple differently packaged stored machine instances and engage with a billing system to share savings with users and manage garbage collection across many encrypted volumes. One benefit to datacenters may be lower overall capital costs, financial gains from withheld portions of storage savings, lower data transport needs, and deduplication tasks that can be performed when the datacenter has spare capacity.

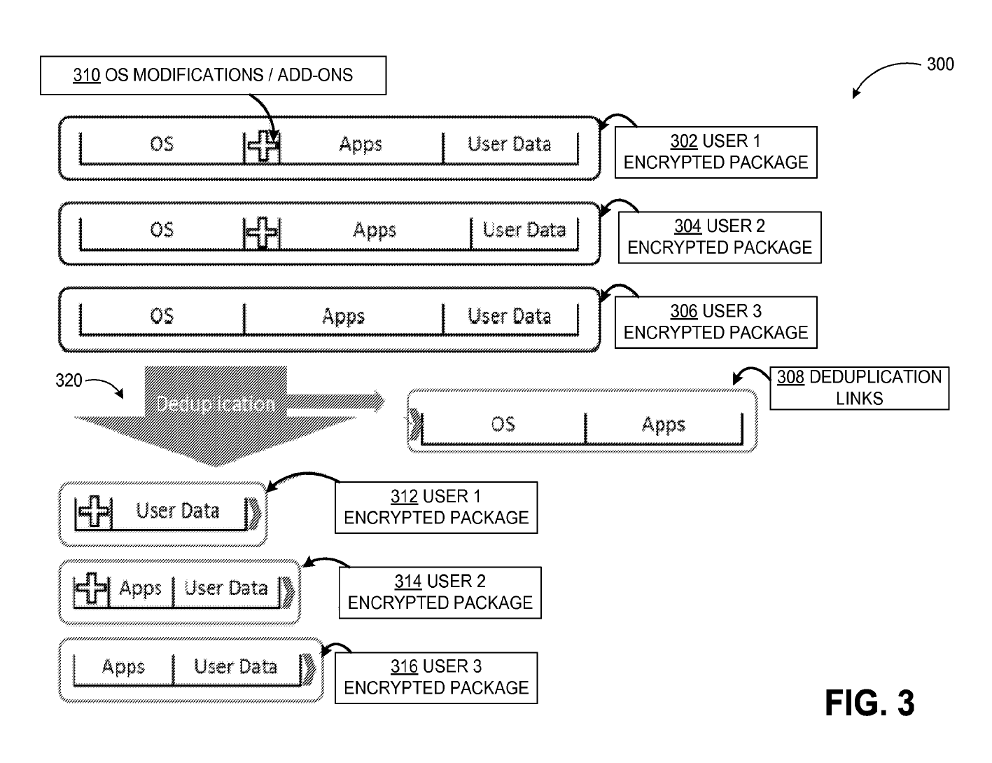

FIG. 3 illustrates an overview of deduplication realization arranged in accordance with at least some embodiments described herein.

As shown in a diagram 300, a datacenter may have discrete encrypted user packages 302, 304, 306 for each user. These packages may be encrypted by the datacenter and the datacenter may have the keys in machine image implementations. Individual user packages may include one or more of an operating system, operating system modification and/or add-ons 310, applications, and/or user data. According to some embodiments, some users may define particular packages as amenable to deduplication, and the system may go through each one, scanning decrypted portions and engaging in deduplication 320 and storing deduplicated data chunks in discrete packages (deduplication links 308) that are owned by the datacenter. The above described deduplication 320 may leave encrypted user packages 312, 314, and 316 including combinations of operating system modification and/or add-ons 310, applications, and/or user data.

It should be noted that the same implementations and methods can be used at different scales, for example offering deduplication within a single user deployment as a service, in which case the user may directly reduce their storage needs and costs, although they may likely have less overall deduplication savings than cross-customer deduplication might offer. Conventional deduplication may not work even on a single-user basis as the data within a single user deployment is in many different packages that are not generally stored in the same place or decrypted at the same time.

A system according to some embodiments may rely on three major elements: ability to access portions of an encrypted machine image without needing to run it or fully decrypt it in place; a process for deduplicating a series of packages and providing billing credits for storage reduction; and a process for serving the resulting deduplicated chunks. Portions of a secure virtual machine package may be exposed and accessed as virtual storage on a network to iteratively work through deduplication flagged packages. The packages may be accessed in part by allowing flagging to exclude state data or they may be accessed sequentially one piece at a time. The latter approach may provide higher security by accessing only the data currently being processed for deduplication and then clearing out memory as a next allotment of data is processed. For further security enhancement, deduplication may be performed in one of the sections of the datacenter that does not allow any outside access, such as a layer that handles low level storage access.

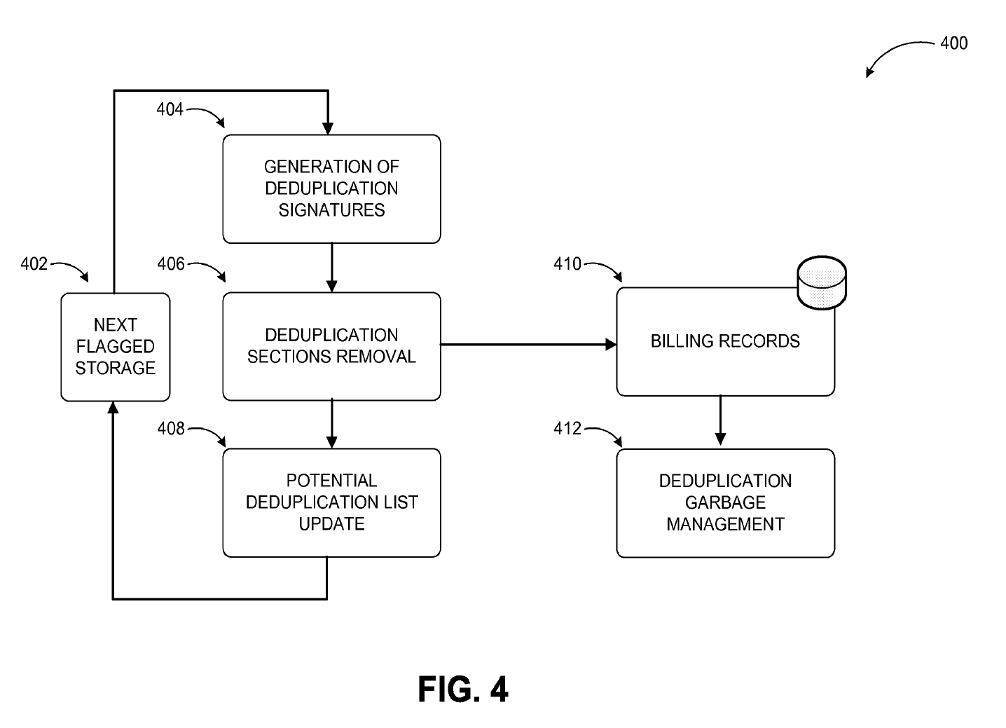

FIG. 4 illustrates an example action flow and components in iteratively deduplicating and billing credits arranged in accordance with at least some embodiments described herein.

As shown in a diagram 400, a storage discount system based on allowing cross-user deduplication may include a generation of deduplication signatures 404 followed by removal of sections flagged as allowed for deduplication 406 (i.e., those sections with a matching deduplication signature or a “hit” in the storage) and update of a potential deduplication list. The process may be iterated through each flagged data storage 402. As deduplicated sections are removed, related billing records 410 may be generated. The billing records 410 may receive tables of links and block sizes that may be used to calculate discounts. Such information may allow total counts of replicas so that the billing discount can be computed based on, for example, a relative percentage of the master deduplication savings that is attributable to each user.

The billing records 410 may also be employed for garbage collection 412 as they are a single data repository for tracking when deduplication is no longer needed in the master. Garbage collection 412 may otherwise be difficult across many separate data packages, requiring constant and comprehensive rescanning of involved volumes. These billing records may also be updated when a user eliminates a deduplicated block, either by deletion or by modification that stops it from being deduplicated. In some embodiments, discounts may take into account an overhead cost of deduplication including processing time. In some example virtual desktop service implementations, operating system and application deduplication may result in large, e.g., sometimes over 90%, savings of disk space.

In a datacenter according to some embodiments, any machine image based on one of the provided library images, for example, may be largely subject to deduplication. Serving the deduplicated data may be performed using a variety of deduplication approaches. When the file system encounters deduplication links, the shared deduplication data may be served transparently and the user may appear to have full copies of all data. If deduplicated data is modified, a modified copy may be written to unique storage as non-deduplicated data and records of use updated.

Some of the datacenter traffic may involve mirroring data between sites so that users can access their data at multiple sites. Deduplication signatures and masters can be shared partially or completely between sites and transfer of a large data store such as a virtual machine can be dramatically reduced to a few deduplication signatures and the non-duplicated data. This may save a datacenter large amount of inter-datacenter traffic. Data backups and data packages for migrating machine images that use deduplicated data may yield similar size reductions as well.

In some scenarios, deduplication may be used to scan a datacenter for target data for malicious purposes. For example, an attacker may flag various permutations of instances for deduplication over time that contain changing data in order to check whether that data exists elsewhere in the datacenter by observing billing credits as the data changes. To prevent misuse of deduplication, discount credits may be calculated involving discrete size steps. Furthermore, internal metrics may also be used in computing discounts such as metrics representing overall gains, how many users a deduplication package is servicing, and so on. Such strategies may introduce noise and unpredictability to the results such that an attacker gains less data. Allowing modification of deduplication flagging credits only on lengthy intervals may also dramatically reduce the ability of an attacker to extract data. A system according to some embodiments may allow for flagging only parts of data stores so a user may simply opt to flag only the operating system and application cores by default.

According to further embodiments, computations performed for deduplication may be a datacenter task that can be performed when spare computation is most cost-effective, and the storage savings from deduplication are large enough that savings can likely be offered for customers while retaining increased earnings for the datacenter. If the data is deduplicated across datacenter locations, then large amounts of traffic can be eliminated by sending only the deduplication signatures instead of many Gigabytes of data as discussed above.

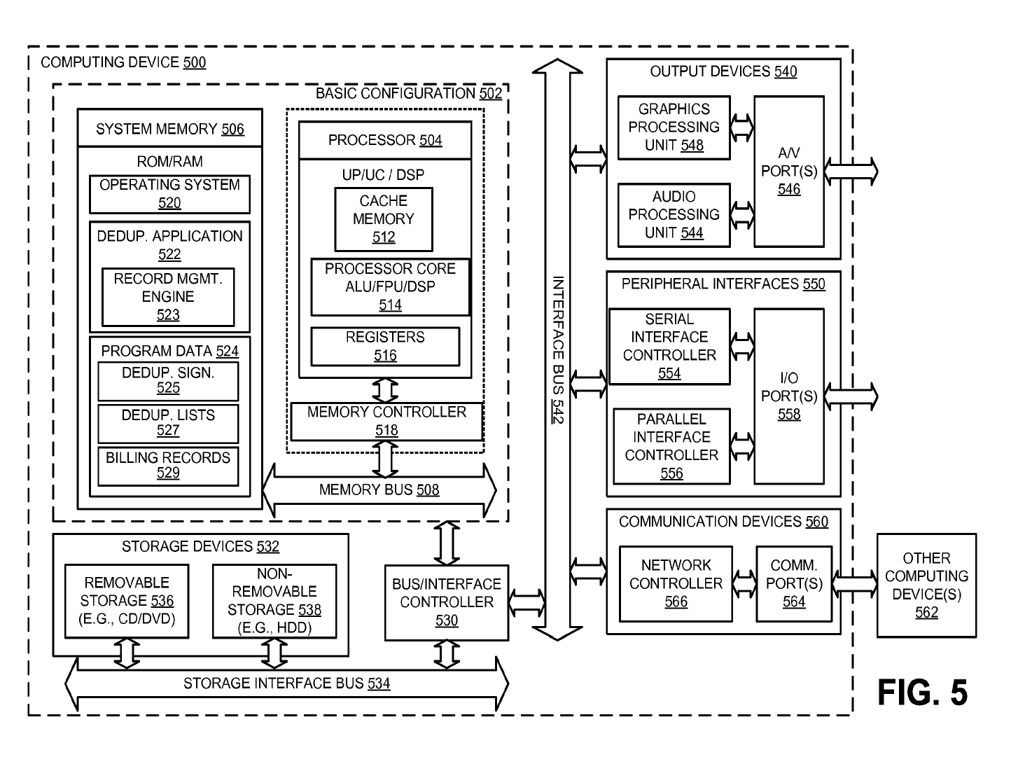

FIG. 5 illustrates a general purpose computing device 500, which may be used to implement storage discounts for cross-user deduplication, in accordance with at least some embodiments described herein. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof The system memory 506 may include an operating system 520, one or more deduplication applications 522, and program data 524. The deduplication applications 522 may include a record management engine 523, which may determine sections of data that can be deduplicated and perform cross-user deduplication as described herein. The program data 524 may include, among other data, one or more deduplication signatures 525, deduplication lists 527, billing records 529, or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500. Some of these storage devices may be configured as deduplicated storage volumes or the connections may be used to connect to deduplicated storage volumes according to some embodiments.

The computing device 500 may also include an interface bus 540 for facilitating communication from various interface devices (e.g., one or more output devices 542, one or more peripheral interfaces 544, and one or more communication devices 546) to the basic configuration 502 via the bus/interface controller 530. Some of the example output devices 542 include a graphics processing unit 548 and an audio processing unit 550, which may be configured to communicate to various external devices such as a display or speakers via one or more AN ports 552. One or more example peripheral interfaces 544 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564. The one or more other computing devices 562 may include servers at a datacenter, user equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods for incentivizing cross-user deduplication in datacenter environments through storage discounts. These methods can be implemented in any number of ways, including the structures described herein. One such way may be by machine operations of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other examples, the human interaction can be automated such as by pre-selected criteria that may be machine automated.

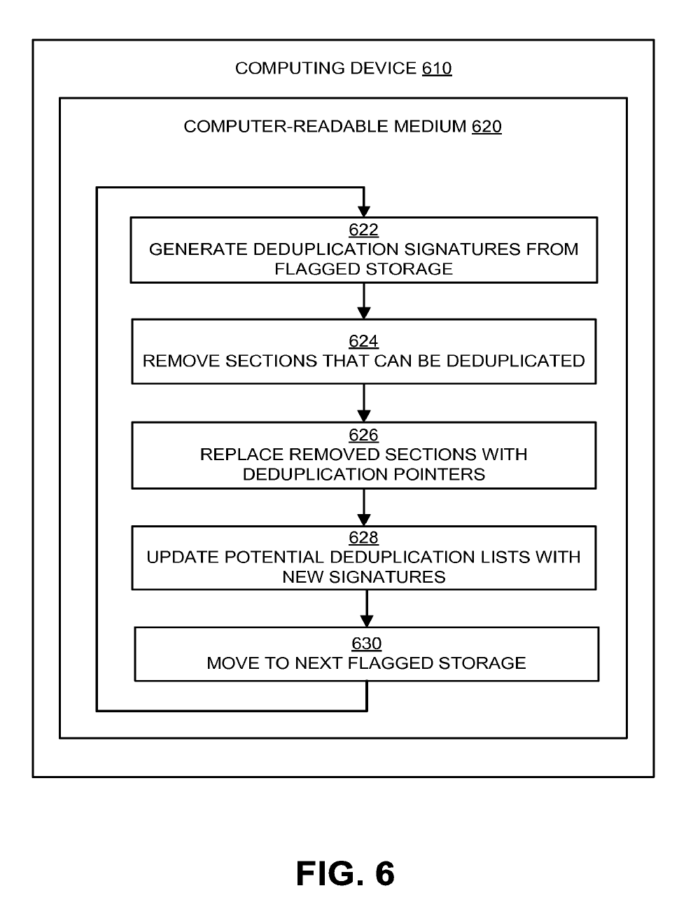

FIG. 6 is a flow diagram illustrating an example method for providing storage discounts for allowing cross-user deduplication that may be performed by a computing device such as the device 500 in FIG. 5, in accordance with at least some embodiments described herein. Example methods may include one or more operations, functions or actions as illustrated by one or more of blocks 622, 624, 626, 628, and/or 630. The operations described in the blocks 622 through 630 may also be stored as computer-executable instructions in a computer-readable medium such as a computer-readable medium 620 of a computing device 610.

An example process of providing storage discounts for allowing cross-user deduplication may begin with block 622, “GENERATE DEDUPLICATION SIGNATURES FROM FLAGGED STORAGE”, where deduplication signatures may be produced by a deduplication module such as record management engine 523 of FIG. 5 on data storage flagged as candidate for deduplication by a user. This may include selective decryption or decompression of a larger storage.

Block 622 may be followed by block 624, “REMOVE SECTIONS THAT CAN BE DEDUPLICATED,” where the sections of data that can be deduplicated such as identical copies of operating systems and applications 227 in a virtual desktop service or virtual machine instance may be removed. Block 624 may be followed by block 626, “REPLACE REMOVED SECTIONS WITH DEDUPLICATION POINTERS”. At block 626, pointers may be stored in place of removed data sections such that the deduplication is transparent to a user and does not impact datacenter performance. Block 626 may be followed by block 628, “UPDATE POTENTIAL DEDUPLICATION LISTS WITH NEW SIGNATURES”, where the record management engine 523 may generate new signatures and update a list of candidate data sections for deduplication as depicted in FIG. 4. Block 628 may be followed by block 630, “MOVE TO NEXT FLAGGED STORAGE,” where the deduplication process may be iteratively repeated through data sections flagged as amenable to deduplication by the user.

The blocks included in the above described process are for illustration purposes. Storage discounts for cross-user deduplication may be implemented by similar processes with fewer or additional blocks, for example, employing blocks depicted in FIG. 1 and FIG. 4. In some examples, the blocks may be performed in a different order. In some other examples, various blocks may be eliminated. In still other examples, various blocks may be divided into additional blocks, or combined together into fewer blocks.

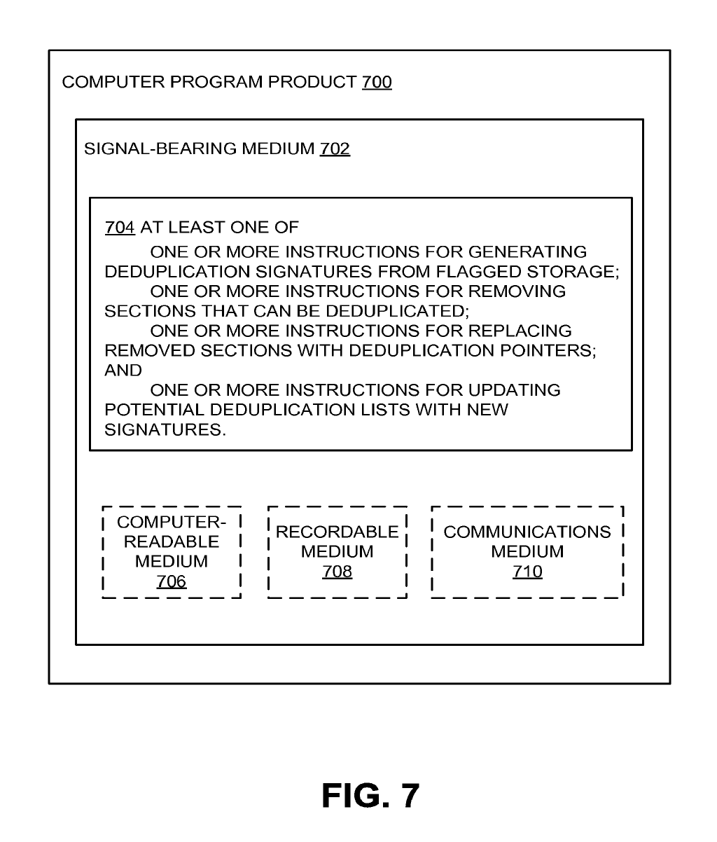

FIG. 7 illustrates a block diagram of an example computer program product 700, arranged in accordance with at least some embodiments described herein. In some examples, as shown in FIG. 7, the computer program product 700 may include a signal bearing medium 702 that may also include one or more machine readable instructions 704 that, when executed by, for example, a processor, may provide the functionality described herein. Thus, for example, referring to the processor 504 in FIG. 5, the record management engine 523 may undertake one or more of the tasks shown in FIG. 7 in response to the instructions 704 conveyed to the processor 504 by the medium 702 to perform actions associated with providing storage discounts for cross-user deduplication as described herein. Some of those instructions may include, for example, instructions for generating deduplication signatures from flagged storage, instructions for removing sections that can be deduplicated, instructions for replacing removed sections with deduplicated pointers, and instructions for updating potential deduplication lists with new signatures, according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, the program product 700 may be conveyed to one or more modules of the processor 704 by an RF signal bearing medium, where the signal bearing medium 702 is conveyed by the wireless communications medium 710 (e.g., a wireless communications medium conforming with the IEEE 802.11 standard).

According to some examples, a method for data storage deduplication across multiple users in a datacenter environment may include determining data storage flagged as available for deduplication, generating deduplication signatures from the flagged data storage, removing sections of the flagged data storage, replacing the removed sections with deduplication pointers, and updating a potential deduplication list with new deduplication signatures generated from the flagged data storage.

According to other examples, the method may also include generating billing records based on the removed sections and providing discounts to owners of the flagged data storage based on the billing records. The billing record may be used to track saved space for discounting to the owners of the flagged data storage and as a garbage collection master reference for tracking usage of deduplication packages. The discounts may also be based on a processing time associated with the deduplication.

According to further examples, the method may include performing one or more garbage management operations in the datacenter based on the removed sections, iteratively generating additional deduplication signatures and removing additional sections, or performing the deduplication when the datacenter has spare capacity. Determining data storage as available for deduplication may include receiving an indication from the owners of data. The deduplication may take into consideration separate encryption and packaging of inactive data modules and machine instances of the datacenter.

According to some examples, the data may include packages including at least one from a set of: an operating system (OS) portion, an OS modification and/or add-on portion, an applications portion, and a user data portion. The method may further include scanning decrypted data portions comprising at least one from a set of: the OS portion and the applications portion for the deduplication, and storing deduplicated data in discrete packages that are owned by the datacenter. Encrypted data portions may include at least one from a set of the OS modification and/or add-on portion, the applications portion, and the user data portion. The packages may be accessed sequentially one package at a time. The deduplication may be performed at a data storage section of the datacenter that does not allow outside access. The method may also include sharing the deduplication signatures between datacenter sites and transferring a virtual machine by transferring deduplication signatures and non-duplicated data associated with the virtual machine.

According to other examples, a server adapted to perform data storage deduplication across multiple users in a datacenter environment may include a memory adapted to store instructions and a processor executing a data management application in conjunction with the stored instructions. The processor may determine data storage flagged as available for deduplication, generate deduplication signatures from the flagged data storage, remove sections of the flagged data storage, replace the removed sections with deduplication pointers, and update a potential deduplication list with new deduplication signatures generated from the flagged data storage.

According to further examples, the processor may generate billing records based on the removed sections and provide discounts to owners of the flagged data storage based on the billing records. The billing record may be used to track saved space for discounting to the owners of the flagged data storage and as a garbage collection master reference for tracking usage of deduplication packages. The discounts may also be based on a processing time associated with the deduplication.

According to yet other examples, the processor may further perform one or more garbage management operations in the datacenter based on the removed sections, iteratively generate additional deduplication signatures and remove additional sections, determine data storage as available for deduplication by receiving an indication from the owners of data, or perform the deduplication when the datacenter has spare capacity. The deduplication may take into consideration separate encryption and packaging of inactive data modules and machine instances of the datacenter.

According to yet further examples, the data may include packages including at least one from a set of: an operating system (OS) portion, an OS modification and/or add-on portion, an applications portion, and a user data portion. The processor may also scan decrypted data portions comprising at least one from a set of: the OS portion and the applications portion for the deduplication, and store deduplicated data in discrete packages that are owned by the datacenter.

According to some examples, encrypted data portions may include at least one from a set of the OS modification and/or add-on portion, the applications portion, and the user data portion. The packages may be accessed sequentially one package at a time. The deduplication may be performed at a data storage section of the datacenter that does not allow outside access. The processor may further share the deduplication signatures between datacenter sites and transfer a virtual machine by transferring deduplication signatures and non-duplicated data associated with the virtual machine.

According to further examples, a datacenter performing data storage deduplication across multiple users may include a plurality of data stores and at least one server for data management. The server may determine data storage flagged as available for deduplication, generate deduplication signatures from the flagged data storage, remove sections of the flagged data storage, replace the removed sections with deduplication pointers, and update a potential deduplication list with new deduplication signatures generated from the flagged data storage.

According to other examples, the server may generate billing records based on the removed sections and provide discounts to owners of the flagged data storage based on the billing records. The billing record may be used to track saved space for discounting to the owners of the flagged data storage and as a garbage collection master reference for tracking usage of deduplication packages. The discounts may also be based on a processing time associated with the deduplication. The server may perform one or more garbage management operations in the datacenter based on the removed sections, iteratively generate additional deduplication signatures and remove additional sections, determine data storage as available for deduplication by receiving an indication from the owners of data, or perform the deduplication when the datacenter has spare capacity.

According to yet other examples, the deduplication may take into consideration separate encryption and packaging of inactive data modules and machine instances of the datacenter. The data may include packages including at least one from a set of: an operating system (OS) portion, an OS modification and/or add-on portion, an applications portion, and a user data portion. The server may also scan decrypted data portions comprising at least one from a set of: the OS portion and the applications portion for the deduplication, and store deduplicated data in discrete packages that are owned by the datacenter.

According to some examples, encrypted data portions may include at least one from a set of the OS modification and/or add-on portion, the applications portion, and the user data portion. The packages may be accessed sequentially one package at a time. The deduplication may be performed at a data storage section of the datacenter that does not allow outside access. The server may further share the deduplication signatures between datacenter sites and transfer a virtual machine by transferring deduplication signatures and non-duplicated data associated with the virtual machine.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one skilled in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for data storage deduplication across multiple users in a datacenter environment, the method comprising:
determining data storage flagged as available for deduplication;
generating deduplication signatures from the flagged data storage;
removing sections of the flagged data storage;
replacing the removed sections with deduplication pointers; and
providing discounts to owners of the flagged data storage based on a processing time associated with the deduplication.

2. The method according to claim 1, further comprising:
generating billing records based on the removed sections; and
providing the discounts to owners of the flagged data storage also based on the billing records.

3. The method according to claim 2, wherein the billing record is used to track saved space for discounting to the owners of the flagged data storage and as a garbage collection master reference for tracking usage of deduplication packages.

4.-5. (canceled)

6. The method according to claim 1, further comprising iteratively generating additional deduplication signatures and removing additional sections.

7. The method according to claim 1, wherein determining data storage as available for deduplication comprises receiving an indication from the owners of data.

8. The method according to claim 1, further comprising performing the deduplication when the datacenter has spare capacity.

9.-16. (canceled)

17. A server adapted to perform data storage deduplication across multiple users in a datacenter environment, the server comprising:
a memory adapted to store instructions; and
a processor configured to execute a data management application in conjunction with the stored instructions, wherein the processor is configured to:
determine data storage flagged as available for deduplication;
generate deduplication signatures from the flagged data storage;
remove sections of the flagged data storage;
replace the removed sections with deduplication pointers^{.} and
provide discounts to owners of the flagged data storage based on a processing time associated with the deduplication.

18.-24. (canceled)

25. The server according to claim 17, wherein the deduplication takes into consideration separate encryption and packaging of inactive data modules and machine instances of the datacenter.

26. The server according to claim 25, wherein the data comprises packages including at least one from a set of: an operating system (OS) portion, an OS modification and/or add-on portion, an applications portion, and a user data portion.

27. The server according to claim 26, wherein the processor is further configured to:
scan decrypted data portions comprising at least one from a set of: the OS portion and the applications portion for the deduplication; and
store deduplicated data in discrete packages that are owned by the datacenter.

28. The server according to claim 26, wherein encrypted data portions include at least one from a set of the OS modification and/or add-on portion, the applications portion, and the user data portion.

29. The server according to claim 26, wherein the packages are accessed sequentially one package at a time.

30. The server according to claim 17, wherein the deduplication is performed at a data storage section of the datacenter that does not allow outside access.

31.-32. (canceled)

33. A datacenter performing data storage deduplication across multiple users, the datacenter comprising:
a plurality of data stores; and
at least one server for data management, the server configured to:
determine data storage flagged as available for deduplication;
generate deduplication signatures from the flagged data storage;
remove sections of the flagged data storage;
replace the removed sections with deduplication pointers; and
provide discounts to owners of the flagged data storage based on a processing time associated with the deduplication.

34. The datacenter according to claim 33, wherein the server is further configured to:
generate billing records based on the removed sections; and
provide the discounts to owners of the flagged data storage also based on the billing records.

35.-39. (canceled)

40. The datacenter according to claim 33, wherein the server is further configured to perform the deduplication when the datacenter has spare capacity.

41. The datacenter according to claim 33, wherein the deduplication takes into consideration separate encryption and packaging of inactive data modules and machine instances of the datacenter.

42. (canceled)

43. The datacenter according to claim 41, wherein the data comprises packages including at least one from a set of: an operating system (OS) portion, an OS modification and/or add-on portion, an applications portion, and a user data portion and the server is further configured to:
scan decrypted data portions comprising at least one from a set of: the OS portion and the applications portion for the deduplication; and
store deduplicated data in discrete packages that are owned by the datacenter.

44.-46. (canceled)

47. The datacenter according to claim 33, wherein the server is further configured to:
share the deduplication signatures between datacenter sites; and
transfer a data store by transferring deduplication signatures and non-duplicated data associated with the data store.

48. The datacenter according to claim 33, wherein the server is further configured to:
update a potential deduplication list with new deduplication signatures generated from the flagged data storage.
